(19) United States
(12) Patent Application Publication
(10) Pub. No.: US 2006/0218618 A1
(43) Pub. Date: Sep. 28, 2006

(54) Dual display interactive video

(76) Inventor: Joseph Ernest Lorkovic, Oceanside, CA (US)

Correspondence Address: Joseph E Lorkovic, 3747-40 Vista Campana South, Oceanside, CA, 92057, US

(21) Appl. No.: 11/384,662

(22) Filed: Mar. 20, 2006

Related U.S. Application Data
(60) Provisional application No. 60/664,462, filed on Mar. 22, 2005.

(51) Int. Cl. H04N 7/173; H04N 7/16; H04N 7/025; H04N 7/10

(52) U.S. Cl. 725/135; 725/32; 725/136; 725/109; 725/110

(57) ABSTRACT

The disclosed process provides software based business methods for interactive content dissemination over the internet and a revenue framework for billing and tracking in relationship to usage by consumers and benefits to content sponsors. The system provides methods for client and server operations and the preparation of interactive video content in conjunction with web browser based content for distribution over the Internet.

### CROSS-REFERENCE TO RELATED APPLICATIONS

THIS APPLICATION CLAIMS THE BENEFIT OF PROVISIONAL PATENT APPLICATION Ser. No. 60/664,462 FILED Mar. 22, 2005

### FEDERALLY SPONSORED RESEARCH

Not Applicable

### SEQUENCE LISTING OR PROGRAM

Not Applicable

### FIELD OF INVENTION

The present invention is generally related to home entertainment content delivery, interactive communications systems, linked video content and the business processes related to interactive content delivery.

### BACKGROUND ART

For many years, there has been a substantial interest in developing a system that enables Internet like functionality in video content generally referred to as Interactive TV. Electronics manufactures, software developers and content providers have not found a way to deliver interactive video content in way that consumers embrace as an acceptable and desirable content type on a mainstream basis. The ideal interactive video system should provide the interaction without disruption to the viewers of the video content. The described desirable interaction is possible with a secondary display. Wireless technologies have matured now to support the bandwidth needed for high resolution wireless video data transport. The present invention concerns a viable implementation of interactivity with video content in conjunction with preferably a secondary video output device that is preferably wireless.

Most consumers find that interaction with video content is uncomfortable on a large display across the room and navigation with TV style remote control units are likewise uncomfortable to use. These factors in conjunction with the disruption of video content viewing for all viewers if one viewer interacts with content renders the interactive TV service an undesirable product for the overwhelming majority of consumers. The interactive video content systems continue to be developed due to the commercial aspects that the traditional content delivery companies would like to take advantage of such as purchasing products from a TV interface, this activity is referred to as Tcommerce. Although consumers have almost no interested in this activity, development and rollout efforts continue to go forward by mainly cable companies. Ultimately consumers are funding this undesired development when paying the related service bills. US congress mandated an open market for the Set-Top-Box traditionally provided by cable service providers and in doing so have opened the future digital home to innovative media access gateway products. The above US congressional mandate in conjunction with the large scale rollout of fiber optics and broadband to the home enables a new competitive market for the delivery of video content to US consumers over the internet.

Consequently, there is a present and future need to resolve this interactive video content delivery deficiency and provide consumers with a desirable and cost effective alternative.

### BRIEF DESCRIPTION OF THE DRAWINGS

All figures are general in nature and in accordance with one embodiment of the present invention.

FIG. 1 illustrates the communications components from the prospective of the content control server; representing an example of one embodiment of the present invention.

FIG. 2 illustrates the communications components from the prospective of the interactive video player; representing an example of one embodiment of the present invention.

### SUMMARY OF CERTAIN EMBODIMENTS OF THE INVENTION

Thus, at least one embodiment of the present invention is to provide an interactive TV system that consumers will desire and provide a new advertising and revenue model for video on demand and for traditional broadcast video service companies operating over the internet. The disclosed system provides dual screen based interactive video and web browser based content provided in conjunction with user specific account status. The term screen is interchangeable with window and display for the purposes of the present invention as the output maybe directed to multiple windows or multiple displays or screens. The present invention contains two main components, a video player component and an interactive video content and advertising placement control server. The described methods used such as text files and database output maybe database files such as XML format or other formats or data streams. Parts of the described metadata may also be encapsulated with the video file or reside in a database that in turn generates files or data output. The transport is described as standard Internet; likewise the protocols are described as standard Internet, all components maybe exchanged for other methods of accomplishing the same tasks. In the preferred embodiment there is only a basic implementation to keep the related aspects and usage simple. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The present invention consists of business methods, processes and related methods of operating web content enabled video services generally intended to for use as an application service provider type business operating over the internet or other proprietary networks or any combination of network transports. The systems content player components are described as web browser based, however, the components may also be implemented in other ways such as executable desktop application based components.

The present invention provides services to users, advertisers, and content providers from a web browser interface. Content providers enter video and related web content and the universal resources locator addresses of the content into the system. Part of the process of entering videos into the system involves providing definitions of advertising spots in the form of internet banner advertising, start points in video play where video commercials maybe played and full page advertisements that maybe cued up at points within the video play time span. The advertising spots are placed into an auction system. Users may access the system using a guest account or preferably create an account. The advantages of creating an account are that the user can receive incentive tokens that maybe used to pay for content and services and the user can list keywords and key phrases of interest to enable the system to provide advertising that is related to the user interests. All accounts are based on a customer master user account where other users maybe setup for content ratings that are deemed appropriate for the defined user, for example adult content blocking. Advertisers can place bids on spots for placement of banner advertisements, video advertisements, and full web page advertisements. The bids maybe for specific spots within a given content offering or maybe based on matching sponsor keywords with user keyword. General bids that are not targeted to any video, location, or keywords may also be placed in the system; however, such non targeted advertising will only be placed into spots if no targeted advertising is available. An important distinction in the present invention's realm of operations is that it operates with hybrid content that's TV and Web based so commercial advertising spots maybe video based or web based or a combination of the two and direct user interaction is taking place from video and web based links. These aspects are accounted for in regard to content owner's options for placing advertising spots to be filled by an auction process that also considers the users preferences when picking the advertisement to fill an available advertising spot.

### DETAILED DESCRIPTION OF CERTAIN EMBODIMENTS OF THE INVENTION

The disclosed embodiments relate to:

(a) to provide a transaction tracking and video server control component;

(b) to provide a standard method of playback of video content in conjunction with synchronized web content;

(c) to provide a standard for content producers to define hyperlinked video hotspots, automatic content cue scheduling, and define available advertising spots within the defined content;

(d) to provide a standard for providing TV like content over the internet and the business model to support the operations in regard to,
1. Free content to consumers based on sponsor support
2. Paid or free content with commercial content based on user account data
3. The basis for web enhanced video content that is non intrusive to the audience
4. The bases for an auction revenue model for interactive content distribution
5. The basis for recording user interactivity and advertising efficiency
6. The basis for a credit system that rewards user's interaction with sponsors;

(e) to provide a standard for websites to launch popup video play components that provide a custom menu listing of content for the website;

(f) to provide a standard auction advertising placement system based on predefined advertising spots that also operates in conjunction with sponsor's and user's interests keyword matching;

Use as a business solution is the intended use for certain examples of the present invention although potentially versions of it will be used in non business related activity such as consumers directly providing interactive video content.

The server component using internet protocols provides interactive video to clients requesting video. The client software requests content and establish if the client has a user account for defined user interests in the form of keywords or key phrases. If the client is not logged into an account the access is based on a guest user. In the case of guest user, non user specific advertising is sent by the server and the server inserts standard video commercial content in the video player interface.

If a video request is from a logged in user the server will send metadata for advertising control specific to the user account before starting the streaming of video or audio content that includes a cue list of advertising content determined by the user defined preferences. The metadata contains directions to provide synchronization of web browser content at pre determined times during playback by the video player application that directs the browser to the specified URLs and may also causes the main video playback to pause while other video commercial content is played. Metadata also provides hot-spot definitions that are looked up if the video screen is clicked on during display of video. The link area is defined by screen coordinates and time being sent to a server and is implemented as a non visible overlay. If no link is present at the screen location a user clicked the player software will preferably direct the browse to a predefined default page.

All metadata content resides preferably on a dedicated database server that is linked to a control server on the internet and is processed per user account and the current pool of available advertising content. The control server controls access to the video servers where the video content is stored. User account data is looked up by the server and the combination of account data in conjunction with sponsors advertising data determine what is sent to the client in response to content request that is advertising based. For example the user may have a history of large amount of interacting with sponsors and making purchases. For this type of user the content preferably will contain few or no video commercials inserted into the video player and preferably will have only browser based commercials to support the sponsor's need to reach potential customers. On the other side of the spectrum, users that have low or no interaction with sponsors or do not have an account would receive the maximum number of all advertising content including video commercials. The system provides opt-in advertising based content to match sponsors products with user's interest thus enabling the user to have some control of the advertising content they will be subjected to and as such may have a more enjoyable experience and higher likelihood of positive interaction with sponsors. This also enhances advertising efficiency for the sponsors that bid on advertising placement using an auction system to place content based on selected video advertising spots defined by the content producer or bids that are based on user interest keyword matching. General non targeted advertising is also used.

The present invention is a system for interactive video content control over IP networks and is not specific to any dual or single display system for playback. The target platform is any system that can provide a web browser window. For the sake of practicality a secondary display for the browser and electronic program guide menu interface separate from the video content should be present. The system provides a simple way for the authors of video and web content to provide user interaction and efficiently distribute content and generate revenue. The original video content is made in the same way non interactive content is made. After the video content is complete the author creates web browser based content as needed for synchronized additional browser based content that enhances the video or audio content. In the case of video, interaction by defined hot spots is available. The related web content is defined by metadata for automated link execution to direct web browser windows to predefined addresses to be launched for a synchronized content affect with audio or video. These links are entered in the metadata so they can be cued for timing of synchronized web browser based content. The hot-spot maps are also entered in the metadata file or database. The described metadata is produced by software that plays back the content for review during the process of defining of hot spots and cue points. The hotspots are defined by left and right lines being drawn on screen that represents the start and end points of the horizontal space between the two defining lines that are generally vertical. This data is later used to build lookup tables when needed. The line data maybe missing some sections or may have only a sampling of the actual lines drawn. The process begins with a video screen having a drawing overlay. The user can play the video to determine the areas that should be a clickable hotspot. The video maybe scrolled forward and backward during editing. When a plan for hotspot mapping is decided on, the mouse pointer is positioned at the starting point top for the left side of the area to be defined and held down while being dragged to the bottom of the left side definition. This sets only the left barrier of the hotspot definition and makes it visible on the screen. During the mouse drag the top vertical position and the bottom vertical position is recorded. The horizontal positions between are recorded without vertical information. The string of vertical only coordinates is positioned based on known top and bottom coordinates and processed to fill any missing pixels with the coordinates of the adjacent known pixels. The right side barrier top and bottom are predefined by the left side recording so only horizontal coordinates are recorded during the right side mouse drag. With the area defined the user may then play the video to determine the start time and end time for the defined hot spot. The definition data includes the link to the content to be loaded and is uploaded to the server. This process is repeated for all area definitions required and the definitions maybe overlapped. The layering is determined by the definition number. The server will fill the blanks between missing data when doing a hot spot lookup. This works well because exact precision of the hotspot definition is not required for good functionality. The amount of data to be stored and transmitted is less than half of what would be recorded if each pixel horizontal and vertical position was recorded. The defined hot spot data is sent to the control server that places it in the database for lookup during video playback. The server chooses a method of reconstruction of the data based on the known top and button of the defined area and checking the percent of horizontal data that is missing. As an example is if only half the data is present the server will write 2 entries in the temporary lookup table per pixel recorded to reconstruct the data. The editor of the preferred embodiment is web based and thus the entire system maybe accessed from the internet.

Playback attributes are set to direct the server in the handling of the content distribution such as providing commercial inserts at defined points during playback dependent on user account and video advertising spots entered by the content producer. The client is assumed to be a media access gateway or set top box such as a home theater PC or Media PC that will most likely serve the content out on for example on an NTSC video output port that will provide content to legacy analog TV sets as well as providing interactive content over networks. The described system may also operate off CD/DVD disks or other storage. The optimal client for this content delivery and playback system is described in patent application “Digital Home Control System”, Ser. No. 20040117835 FILED Sep. 22, 2003. The system may also operate from a laptop computer that may send video to a secondary display by wireless connection.

The present invention's content server is a combination transaction tracking and video on demand control system that serves advertising based on user account preferences and currently available advertising while providing back end processing for the video player interface and it's menu system that is also known as a Electronic Program Guide. The components can operate with optional startup parameters for launching specific menus and preloading content. The Electronic Program Guide has a small video screen that plays preview video for a selected menu item. Sponsors of content that have customers respond to advertising are recorded and purchases are also recorded through ecommerce system post back. The server maybe accessed by merchants using a web based interface to give credit to consumers that interact or make purchases. This data maybe used by the database server to determine how to handle customer's future content requests and issuance of rewards tokens that are redeemable in the form of premium content and services. User attempted interaction with video content that has no hot spot maybe assigned a default link and this type of action is also recorded by the server so the author of the content can review items that users had an interest in clicking on but were not assigned a link maybe known for update edits and general reference. The server uses multiple sources to determine its actions based on adjustable settings within the server, the user account information, and the available advertising content relating to a video or relating to keywords. The present invention provides a standard for managed operation and control of multiple video servers throughout the internet. The system works independent of video servers; however, it maybe embedded as part of a video server software program.

The process for determining an advertisement for placement into an advertisement spot generally involves selecting the current bidder that has a match with the current user's keywords or a bid specific to the advertising slot. If no matches are found then the system selects an ad from the general ad pool not targeted to any specific user keyword or advertising slot.

User's state and city location are automatically considered as keywords so sponsors that want to target areas may do so using those location keywords. This method provides for the best of both worlds in regard to keyword matching, area targeting, and the price a bidder is willing to pay a content owner for the advertising spot.

With the use of the disclosed methods the system can give better service to users by providing advertising content of interest while providing better service to advertisers by enabling them to efficiently reach potential customers while also providing an auction system that enables the content owners to maximize revenue from the content.

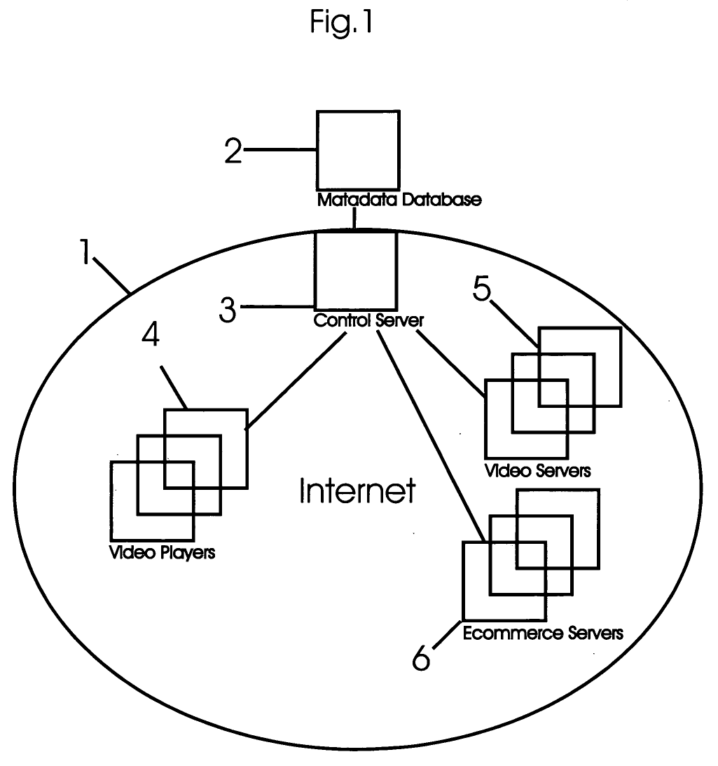

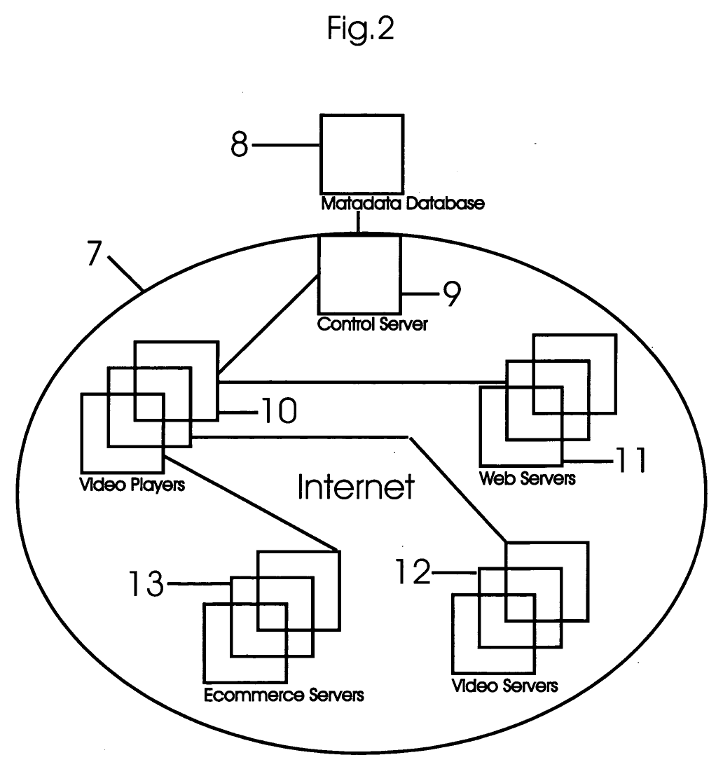

From the prospective of the content delivery control server the preferred embodiment consists of a 2 database server that provides storage and processing for the 3 control server that provides 4 player components and metadata to the user over the 1 internet in accordance with the present invention is shown in FIG. 1. The 3 control server may provide password control for content residing on 5 video servers and 6 ecommerce servers may provide purchase information that will have a positive affect on the users account maintained on the 3 control server in accordance with the present invention is shown in FIG. 1. From the prospective of the client accessing the system on the 7 internet the preferred embodiment consists of 11 web server that provides a link that loads a customized version of the 10 video player in accordance with the present invention is shown in FIG. 2. The program guide provides access to content stored on 12 video servers and clicks on video are looked up on the 9 control server and the 10 video player opens or updates a browser window for content from 11 web servers in accordance with the present invention is shown in FIG. 2.

Appendix “A”—Source and Object Code Submission

Two CD ROMs with select source code in file Appendix “A”.rtf and other object code and source code files are submitted with this application.

What is claimed is:

1. A video metadata means for allowing video content to be interactive enabled with the use of a corresponding metadata set comprising:
(a) metadata relating to hot spot mapping used by a video display component that provides a means for interaction with video hot spot links that load in a separate window;
(b) video player that reads metadata and controls a range of web browser instances in conjunction with metadata directions during playback providing synchronization of a separate content window with the playing video.

2. The video display control system of claim 1, further including a means for interaction with video hot spots that triggers video to be replaced in the video screen.

3. A web browser based video player component set with separate video screen and separate control interface consisting of a popup component set comprising;
(a) a video display component;
(b) a video playback control component that controls said video display component.

4. A web browser based video player component set having a means for launching from any website comprising a custom menu based on the web site the components are launched from.

5. A web browser based video player component set with a video player menu having a preview video screen for the selected menu item separate from the primary video screen.

6. A content delivery and related advertising auction control system wherein the advertising spot definitions consist of video and related content defined in conjunction with automatic cue points and hot spots wherein the content launched is web based content developed for said cue points and hot spot definitions.

7. The content delivery control system of claim 6, further including a means for video and audio content to be placed in the content delivery control system to make it available for launch from any website.

8. The content delivery control system of claim 6, further including a means for advertisers to bid on advertising spots based on specific content or based on user keyword match up with an advertiser defined keyword set.

9. The content delivery control system of claim 6, further including a means for routing of advertisements based on user location when user location is known.

10. The content delivery control system of claim 6, further including a means for content producers to define videos, hot spots, and cue data related to the video from a web browser interface.

12. The content delivery control system of claim 6, further including a means for advertising spots to be filling by routing advertisements based on the combination of winning bids and user specific data.

13. The content delivery control system of claim 6, further including a means for tracking user interaction levels and user purchasing level data.

14. The content delivery control system of claim 6, further including a means for the accounting of all advertising auction related activity for video providers and the placement of sponsor advertising in response to winning auction bids.

15. The content delivery control system of claim 6, further including a means for user incentive related to activity with sponsors by maintaining an account of token credits for users where by the tokens may enable the user with a range of benefits and provide the sponsors with a means of rewarding user's interaction.

16. A means of video hotspot definition data mapping compression wherein top and bottom definition points of vertical coordinates are saved only once and a sampling of horizontal coordinates are saved without the corresponding vertical data.
